(19) United States
(12) Patent Application Publication
(10) Pub. No.: US 2022/0157105 A1
(43) Pub. Date: May 19, 2022

(54) KIOSK

(71) Applicant: Sonia Varrasso, Gibsonia, PA (US)

(72) Inventor: Sonia Varrasso, Gibsonia, PA (US)

(21) Appl. No.: 17/369,734

(22) Filed: Jul. 7, 2021

Related U.S. Application Data
(60) Provisional application No. 63/115,948, filed on Nov. 19, 2020.

(51) Int. Cl. G07C 9/25; G07C 9/27; G07C 9/29; G07C 9/00

(52) U.S. Cl. CPC G07C 9/257; G07C 9/27; G07C 9/00182; G07C 9/00896; G07C 9/29

(57) ABSTRACT

A system for confirming an individual's identity prior to access to a secure area. The system includes a network, the network connecting the components of the system to one another. The system also includes a database, the database storing information including a user profile. The system further includes a security kiosk. The security kiosk in electronic communication with the database over the network and configured to allow a user to confirm his/her identity by sending one or more pieces of identifying information to the database for comparison to the user's profile. The system additionally includes an access portal. The access portal in electronic communication with the database and the security kiosk over the network. The access portal configured to prevent access to a secure area prior to confirmation of the user's identify and allow access to the secure area after confirmation of the user's identity by the security kiosk.

### CROSS-REFERENCE TO RELATED APPLICATIONS

This application claims the benefit of and priority to U.S. Provisional Patent Application Ser. No. 63/115,948 filed on Nov. 19, 2021, which application is incorporated herein by reference in its entirety.

### BACKGROUND OF THE INVENTION

Security Kiosks suffer from a number of drawbacks. In particular, security kiosks require a high level of interaction with a human user. That is, they are generally configured for use by security personnel. Those that aren't are configured for security personnel to enter the data and have a very narrow function of allowing the user to scan a particular id (usually containing an RFID chip) issued to a user.

However, this includes a number of drawbacks. For example, the number of security y personnel may be limited. For example, in an office setting there may only be a single member of a security force available at any one time. This can create a bottleneck when multiple registrations are needed. At larger events, security personnel are generally hired on a temporary basis, which reduces the level of training and, therefore, the overall security of the event.

In addition, the entry process is typically manual. That is, the security personnel are gathering information, then manually entering the information. This can lead to errors. For example, security personnel may issue an employee badge but type in the wrong employee number. This can lead to problems down the road.

Accordingly, there is a need in the art for a security kiosk which can allow automated access. Further, there is a need in the art for a security kiosk which can include automatic data entry.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for confirming an individual's identity prior to access to a secure area. The system includes a network, the network connecting the components of the system to one another. The system also includes a database, the database storing information including a user profile. The system further includes a security kiosk. The security kiosk in electronic communication with the database over the network and configured to allow a user to confirm his/her identity by sending one or more pieces of identifying information to the database for comparison to the user's profile. The system additionally includes an access portal. The access portal in electronic communication with the database and the security kiosk over the network. The access portal configured to prevent access to a secure area prior to confirmation of the user's identify and allow access to the secure area after confirmation of the user's identity by the security kiosk.

Another example embodiment includes a security kiosk for confirming a user's identity prior to access to a secure area. The security kiosk includes a memory and a processor coupled to the memory programmed with executable instructions. The instructions including receiving identifying data from a user and sending the identifying data to a database containing user profiles. The instructions also including receiving from the database a communication about whether the identifying data matches data in a user profile and allowing access to a secure area when the identifying data matches data in a user profile. The instructions further including preventing access to the secure area when the identifying data does not match data in a user profile. The security kiosk also includes a touch screen, where the touch screen is configured to allow a user to enter and receive information regarding the identifying data and a camera, where the camera is configured to capture one or more images, the one or more images related to the identifying data.

Another example embodiment includes a method of allowing a user to register on a security kiosk. The method includes providing a welcome screen and obtaining the user's identifying information. The method also includes obtaining the user's identification and associating the user's identification with the user's profile. The method further includes obtaining biometric data from the user and associating the biometric data with the user's profile. The method additionally includes receiving a payment from the user and sending the user a code. The method moreover includes completing registration and providing entry to a secure area.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a system for confirming an individual's identity prior to access of a secure area;

FIG. 2 is a flow chart illustrating a method of confirming a user's identity prior to access to a secure area

FIG. 3 illustrates an example of a security kiosk;

FIG. 4 is a flow chart illustrating a method of allowing a user to register on a security kiosk;

FIG. 5A illustrates an example of a first registration interface;

FIG. 5B illustrates an alternative example of a first registration interface;

FIG. 6 illustrates an example of a second registration interface allowing the user to enter i.d.;

FIG. 7 illustrates an example of a third registration interface allowing the user to enter biometric data;

FIG. 8A illustrates an alternative example of a fifth registration interface allowing the user to make payments after registration is complete;

FIG. 8B illustrates an example of a payment interface;

FIG. 8C illustrates an alternative example of a payment interface;

FIG. 9 illustrates an example of a screen requiring a code sent to a user;

FIG. 10A illustrates an example of a fourth registration interface allowing the user to see registration steps that are complete;

FIG. 10B illustrates an alternative example of a fourth registration interface allowing the user to see registration steps that are complete;

FIG. 10C illustrates an alternative example of a fifth registration interface showing that registration has failed;

FIG. 11A illustrates an example of a sixth registration interface after payment is complete;

FIG. 11B illustrates an alternative example of a seventh registration interface showing that registration is complete;

FIG. 12A illustrates an example of a special event registration interface;

FIG. 12B illustrates an alternative example of a special event registration interface;

FIG. 13 is a flow chart illustrating a method of allowing a user to renew a registration on a security kiosk;

FIG. 14A illustrates an example of a first registration renewal interface;

FIG. 14B illustrates an example of a second registration renewal interface;

FIG. 15 illustrates an example of a third registration renewal interface; and

FIG. 16 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

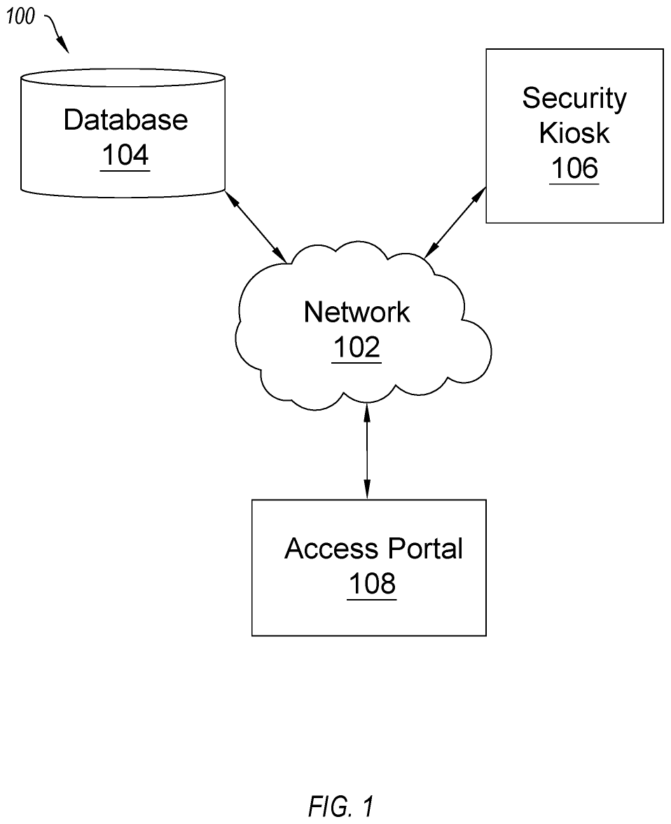

FIG. 1 illustrates a block diagram of a system 100 for confirming an individual's identity prior to access to a secure area. The secure area can be any area that has restricted access. For example, the secure area can include a lab, an office area, a member's section of a building, etc. The system 100 is configured to confirm that the individual is who he/she says he/she is and then allows access to the secure area. This is done quickly and securely to allow access in a timely manner. The user's identity can be associated with other data. For example, if access to the secure area requires a membership or payment then the system 100 can include information on whether the user has a current membership, has made a prior payment, has funds in an account that can be used to make a payment, allows for making a concurrent payment, etc. I.e., confirming an individual's identity includes all aspects of confirming that the user should be allowed access to the secure area. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

The following is an outline of some functions that can be carried out by the system 100.

### Kiosk Management: Kiosk App and Web Application

1. Kiosk App

a. Membership Mode
i. Membership Signup
   1. Scan Palm: If not a member: prompt to membership sign up form
      a. Scan Document
      b. Auto fill following fields (user can change these fields if required)
         i. First name
         ii. Last name
         iii. Address
         iv. DOB
         v. Validate above fields
      c. Verify Age
      d. Scan Face
      e. Validate Face with document photo
         i. If face match, pay fee by Cash or Credit Card
         1. If user request receipt, ask for email address and email receipt.
         2. Save Data into database
         ii. If face does not match, access denied
         1. Discard Data and return to home screen.
   2. Scan Palm: if an active member: Allow Entry
      a. Return to home screen
   3. Scan Palm: if an expired member: prompt to renew membership form
      a. if accept, Pay fee by Cash or Credit Card
         i. Grant access
         ii. Return to home screen
      b. If cancel, deny entry
         i. Return to home screen

b. Event Mode
1. Scan Palm: If never attended event previously: prompt to membership sign up form
   a. Scan Document
   b. Auto fill following fields (user can change these fields if required)
      i. First name
      ii. Last name
      iii. Address
      iv. DOB
      v. Validate above fields
   c. Verify Age
   d. Scan Face
   e. Validate Face with document photo
      i. If face match, pay fee by Cash or Credit Card
         1. If user request receipt, ask for email address and email receipt.
         2. Save Data into database
      ii. If face does not match, access denied
         1. Discard Data and return to home screen.
2. Scan Palm: If attended event Previously, Access account
   a. Pay fee by Cash or Credit Card
      1. If user request receipt, ask for email address and email receipt.
      2. Save Data into database

2. Web Application
a. Login Module
   i. Password change
   ii. Forgot password
b. Manage Members
   i. Admin can edit members' data
   ii. List of fields
      1. Name
      2. Full Address
      3. Date of Birth
      4. Driver's License or passport image of identification
      5. Membership date of election, status of membership, date of expiration, and date of withdrawal
      6. Membership Level (social, active, officer, steward) *tagable*
      7. Tagged Behavioral
         a. Suspended (automatic 30 days)
         b. Revoked
      8. Email address
      9. Picture of applicant face recognition—used as door entry backup
      10. Fingerprint account retrieval and door access—used as door entry backup

c. Generate different reports (please see below)
i. Member data
   1. Entire membership list (aka “Membership Roll” (with the data being stored for at the last 2 years of data including members who are current, members who have yet to renew, etc.)
   2. New Members (someone who has not been a member, either never a member or an expired member from over 2 years ago)
   3. Renewals
   4. Current members (all members, regardless of type of membership)
   5. Inactive (members who have let their membership expire but no older than 2 years old)
   6. Revoked Memberships (a customer who cannot ever re-enter the club. This data needs to be retained permanently.)
   7. Suspended memberships (this is a customer who is temporarily not welcome in the club, perhaps for 30 days. We need to be able to edit this)
   8. “Social” members (this is a type of membership that is open to all who apply)
   9. “Active” Members (this is a type of membership reserved for officers and select members of the club)
   10. Officers & Steward
ii. Financial transaction
   1. Annual and Quarterly
   2. Weekly and Monthly
iii. Audit
   1. Date\Time Range selection
   2. Daily Attendance Log
iv. Template Management System
   1. Create report tool to generate and save reports
v. Membership Roll Report
   1. Quarterly Roll Report

3. Support/Maintenance:
a. Tool to access different Kiosk machines data remotely.
b. Low level logging for debugging purposes

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud-based networking and computing. The network 102 can also include servers that enable one type of network to interface with another type of network.

FIG. 1 also shows that the system 100 can include a database 104. The database 104 can store information to confirm a user's identity. In particular, the database 104 can include any device that is capable of storing data. The data can be stored in digital form or in any other desired form. For example the database 104 can include memory or memory banks. Additionally or alternatively, the database 104 can run one or more applications which are accessed over the network 102. For example, the database 104 can include processors or other logic devices capable of executing software or carrying out other computer algorithms. The database 104 can allow a security kiosk 106 to access the hardware of the database 104 for remote computing or for information retrieval.

FIG. 1 shows that the system 100 can include a security kiosk 106. The security kiosk 106 allows a user to confirm his/her identity. I.e., the security kiosk 106 is interactive in some way. The interaction may be automatic (e.g., face detection or reading a microchip carried by the user—as in a security pass) or can be manual (e.g., a fingerprint scan, id scan, entering of a pin or password, etc.). The security kiosk 106 can send the information obtained from the interaction to the database 104 over the network 102 where it will be compared to user data. The database 104 then sends the result of the comparison back to the security kiosk 106 over the network 102.

FIG. 1 additionally shows that the system 100 can include an access portal 108. The access portal 108 is the physical barrier to the secure area that must be passed by the user. For example, in its simplest form, the access portal 108 is a door, which is unlocked when the user's identify is confirmed. The access portal 108 can get more complicated as needed. For example, the access portal 108 can include privacy screens or clean room doors.

One of skill in the art will appreciate that one or more components of the system 100 can be combined with one another. For example, the security kiosk 106 and the access portal 108 can be a single device where the user interacts to have his/her identity confirmed then grants access. Likewise, the database 104 can be included in the security kiosk 106.

One of skill in the art will also appreciate that the communication within the system 100 must be quick and robust. In particular, the identity of the user must be confirmed quickly. Delays can quickly add up. For example, in a setting such as a concert if confirmation of the user's identity and payment status are delayed by even a few seconds that can add minutes or hours to the total line time, causing extreme customer dissatisfaction.

One of skill in the art will understand that the registration kiosk, the access kiosk, and the database can be housed together or near one another, can be in communication with one another, or can be completely separate from one another. For example, from a user's perspective, there can be a single security kiosk 106 that allows a user to register, stores the relevant information in the database, then provides access to the desired area.

In contrast, a user can come into an entry area and proceed to an access portal 108. The access portal 108 can include the same hardware as the security kiosk 106, or other hardware as needed by the client. As the user attempts entry, the access portal 108 gathers data (e.g., scans photo i.d., gathers biometric data, etc.). The access portal 108 then searches the database 104 to determine if the gathered data matches an authorized user. If so, then the user is granted or denied access. If the information does not match any data in the database 104, then the user is directed to a security kiosk 106 to register.

Different configurations provide different benefits. In particular, the registration process may take much longer than the access process and any payment processes may take longer than the latter but be faster than the former. While having both the security kiosk 106 and the access portal 108 in a single unit allows a user to complete all tasks at a single location it does mean that other users may have to wait for registration and access to occur. That means that lines move at unpredictable rates. In contrast, if the access portal 108 and security kiosk 106 are different units, lines are predictable and traffic flow is improved but greater space is required. Nevertheless, different configurations allow for optimization within different settings.

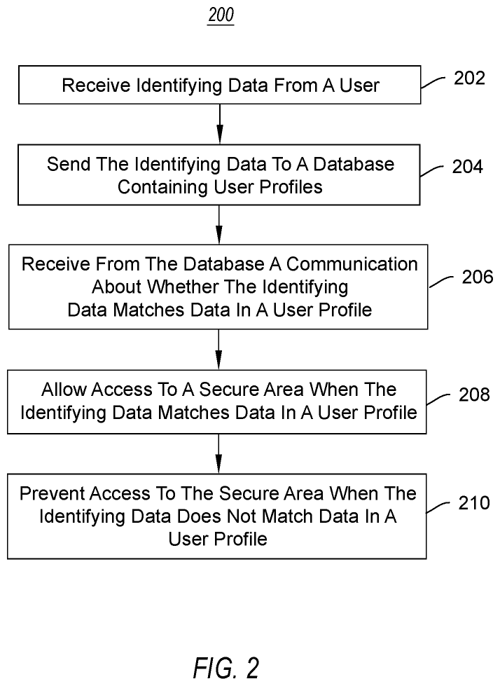

FIG. 2 is a flow chart illustrating a method 200 of confirming a user's identity prior to access to a secure area. The method 200 can be implemented by the security kiosk 106, the access portal 108, or some combination thereof. The method 200 can be stored in memory and implemented by a processor coupled to the memory, as can the other methods given below.

FIG. 2 shows that the method 200 can include receiving 202 identifying data from a user. The identifying data can include printed data, such as a driver's license, or biometric data. Further, the identifying data can include allowing a user to log into an account (e.g., a username and password). The identifying data is dependent on the security needs of the customer and can vary greatly.

FIG. 2 shows that the method 200 can also include sending 204 the identifying data to a database containing user profiles. The identifying data needs to be compared to stored identifying data in order to determine whether a user profile already exists for the user. That is, the identifying data needs to be compared to previously stored data to confirm whether the user is allowed access to the secure area. The identifying data can be sent 204 to the database over a network connection.

FIG. 2 shows that the method 200 can further include receiving 206 from the database a communication about whether the identifying data matches data in a user profile. The database will make a determination about whether the identifying data is found in a user profile. The database will then communicate whether or not a match has occurred.

FIG. 2 shows that the method 200 can additionally include allowing 208 access to a secure area when the identifying data matches data in a user profile. That is, if the identifying data is matched to a user profile, then the user is authorized and access is granted.

FIG. 2 shows that the method 200 can moreover include preventing 210 access to the secure area when the identifying data does not match data in a user profile. A failure to make a match means that the user is not authorized to enter the secure area. That can be changed or updated with registration, but the user will have to take additional steps. There may be instances when the identifying data is matched to a user profile which has expired or had access removed, but the communication from the database need not include those details and can instead simply declare that no match has been made.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

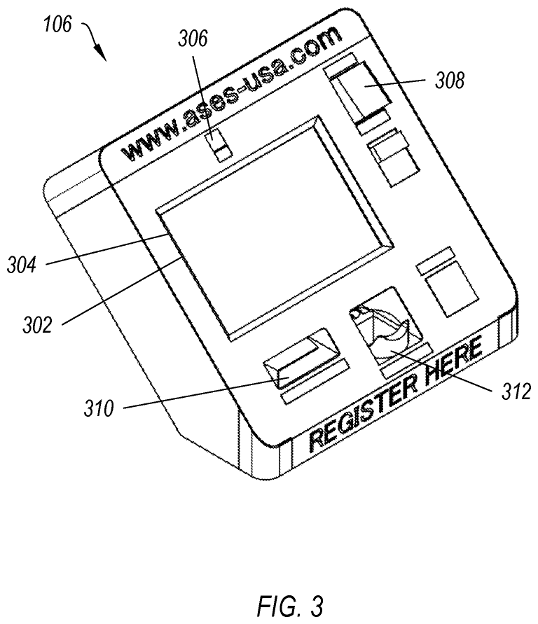

FIG. 3 illustrates an example of a security kiosk 106. The security kiosk 106 prevents entry unless the user confirms his/her identity. Identity confirmation can include biometric identifications and/or documentary identification. The security kiosk 106 can be used at border control, educational facilities, banks and federal applications, bars, nightclubs, membership clubs, sporting events, voter registration or any other event when security is desired. The security kiosk 106 can also allow for payment or other transactions to occur within a private area. For example, the security kiosk 106 can be housed in a separate room or cubicle surrounded by screens or panels which prevent onlookers. When the identification and/or payment is complete the user is automatically granted entry. The security kiosk 106 includes security overrides that allows security personnel to restrain an individual or remove barriers in an emergency.

The security kiosk 106 has several important features. Some of these features include:

1. Integrates with anti-piggyback mantrap doors, circle lock doors, standard doorways, and revolving doors
2. Driver's license and passports are authenticated and verified with 3rd party integration platforms
3. Integration with detectors for security examples firearm or metal
4. Provided attendance roll call to any and all facilities
5. Integration with any travel organizations (train, buses, and airports)

The security kiosk 106 can include features that are customizable based on the needs of the user. The security kiosk 106 can be used by schools, banks, ticketed events, boarder control, voter registration, social clubs, office buildings, etc.

FIG. 3 shows that the security kiosk 106 can include a touch screen 302. The touch screen 302 allows the user to input information using a user interface. FIG. 1 additionally shows that the system 100 can include a user interface. The user interface can allow the user to input or receive information. For example, the user interface can present to the user required information and can allow the user to input information in response. The user interface can include a graphical user interface, controls, speakers, displays or any other necessary hardware and/or software to adequately display the desired information to the resident and/or his/her supervisor(s), as described below.

In at least one implementation, a graphical user interface (“GUI” sometimes pronounced gooey) is a type of user interface that allows users to interact with electronic devices with images rather than text commands. GUIs can be used in computers, hand-held devices such as MP3 players, portable media players or gaming devices, cell phones, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

By way of example, the user interface can include a computer program, app, webpage, website, or some other means for conveying desired information to a supervisor. For example, the user interface can include a website that allows a user to input the required information and/or log into a desired account. Additionally or alternatively, the user interface can allow the user to enter information directly. I.e., the user interface can present a touch keyboard that allows a user to enter a pin or type in required information, such as the user's name.

FIG. 3 also shows that the security kiosk 106 can include a scanner 304. In the security kiosk shown, the scanner 304 and the touch screen 302 are combined with one another. That is, the same physical element is both a touch screen 302 and a scanner 304. For example, when so prompted, the user can place a document on the scanner 304 which is then scanned and entered in the database. The scanner 304 can be used to read barcodes and/or QR codes or other printed identifiers.

FIG. 3 further shows that the security kiosk 106 can include a camera 306. The camera 306 is an optical instrument used to capture an image. The image captured by the camera 306 can vary depending on the stage in identity confirmation. For example, in the initial stages, the camera 306 can be used to capture an image of the user's face. In later stages, the camera 306 can scan the user's face to be compared to the initial image (which can be a dynamic process that occurs as the user walks by). The camera 306 can also be used to capture documents or any other desired function. One of skill in the art will appreciate that the scanner 304 can be integrated with the camera 306 rather than the touch screen 302.

FIG. 3 additionally shows that the security kiosk 106 can include a biometric scanner 308. The biometric scanner 308 can include any device that is able to obtain biometric data from a user. Biometrics are body measurements and calculations related to human characteristics. Biometric identifiers are the distinctive, measurable characteristics used to label and describe individuals. Biometric identifiers are often categorized as physiological characteristics, which are related to the shape of the body. Examples include, but are not limited to fingerprint, palm veins, face recognition, DNA, palm print, hand geometry, iris recognition, retina and odor/scent.

FIG. 3 moreover shows that the security kiosk 106 can include a payment input 310. The payment input 310 allows a user to make a payment when required (for example, when purchasing concert tickets or a club membership). For example, the payment input 310 can include a credit card reader or NFC payment system. One of skill in the art will appreciate that the payment input 310 can be associated with or combined with the user interface. For example, the user interface can allow a user to log in to his/her account and apply previously stored payment information or allow a user to pay via electronic payment systems such as PayPal.

FIG. 3 also shows that the security kiosk 106 can include a printer 312. The printer 312 can be used to provide a printout if needed by a user. For example, the printer 312 can print receipts of tickets to be given to a user. The user can then user the printed material later of simply have them for his/her records.

By way of illustration, some of the main functions of the security kiosk 106 will be described relative to the components defined above. These functions include: 1) Registration kiosk; 2) Access kiosk; and 3) Software/customization of database (with a Linux based operating system and a web-based system which allows for remote access).

The registration kiosk allows a user to create a new profile. I.e., if the user is using the security kiosk 106 for the first time, then there must be a way for the security kiosk 106 to create a profile to identify the user for future identifications. The registration kiosk uses:
Touch Screen 302
Document scanner—integrated with document authentication and verification 304
Vein hand palm biometric scanner 308
Barcode reader (scanner 304 or camera 306)
Camera 306 integrated with biometric facial recognition
Payment options cash or credit card including contactless option 310

The access kiosk uses:
Monitor 302
Vein hand palm biometric scanner 308
Barcode reader (scanner 304 or camera 306)

The database uses:
Touch screen to allow a user to:
   Creates an account
   Request phone number and email
Scanner 304 to allow a user:
   Scan i.d., such as passports or driver's licenses and takes image from identification
Camera 306 will compare individual standing at the registration kiosk and picture from the form of identification submitted and compare to prove they are who they say they are
Vein hand palm biometric scanner 308
Payment options cash or credit card including contactless option 310
After registration is complete a barcode will be emailed, printed or texted with receipt or not. This is the bases of our information in the database. The database can be customized to student identification cards, employee tag numbers, voter registration numbers, tickets numbers, social security numbers, bank account numbers, etc. The customization of the information request is endless per customer's request. The kiosk can be customized for indoor and outdoor use. Finally, the system can be integrated with optic scanner and more.

After registration in the database, the access kiosk performs the following functions:
The user will scan sent barcode
Scan vein hand palm to gain access
Security entrance integration as requested and can be zoned in specific areas

Some of the options that can be customized by users include:
Options—all customization Software allows user accounts to be tagged
Approved entry
Denied entry
30 day suspended entry
Revoked user
Expired user
If payment is required and access has expired the user will go back to the registration kiosk and scan barcode and vein hand palm to access their account to renew the access privilege.

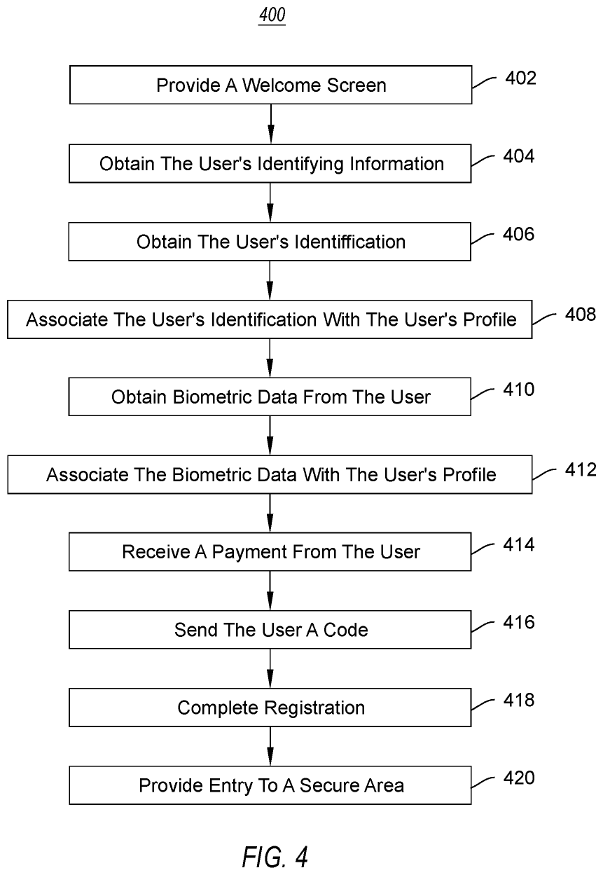

FIG. 4 is a flow chart illustrating a method 400 of allowing a user to register on a security kiosk. In at least one implementation, the security kiosk can have a hardware configuration similar to the security kiosk 106 of FIG. 3. Therefore, the method 400 will be described, exemplarily, with reference to the security kiosk of FIG. 3. Nevertheless, one of skill in the art can appreciate that the method 400 can be used with a security kiosk other than the security kiosk 106 of FIG. 3.

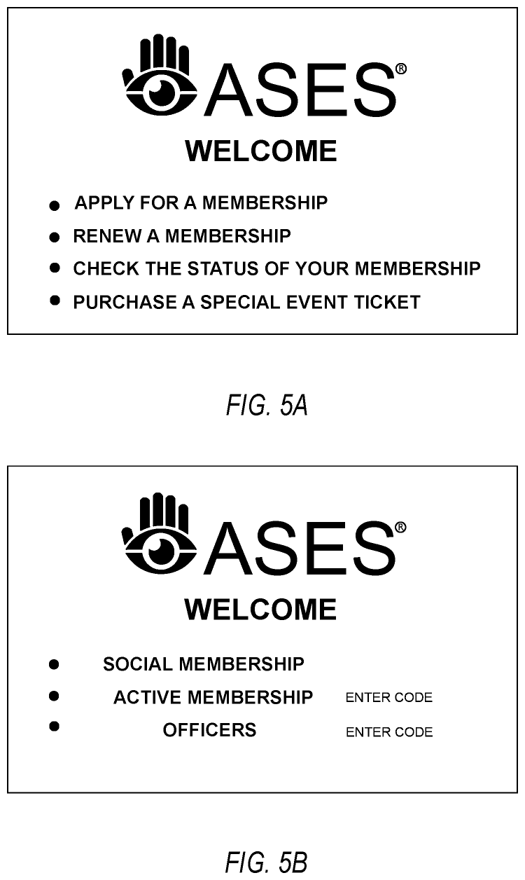

FIG. 4 shows that the method 400 can include providing 402 a welcome screen. The welcome screen allows the user to begin the registration process. Typically, the welcome screen will allow a user to select from different options (e.g., new membership, renew membership, check membership status, etc.). I.e., the welcome screen introduces the user to the process of verifying identity, registering, making payments, etc. Examples of welcome screens can be seen in FIGS. 5A and 5B.

FIG. 4 shows that the method 400 can also include obtaining 404 the user's identifying information. Identifying information can include things like name, address, age, physical description, etc. Identifying information can also include things like usernames and passwords. This information, once obtained 404, is used to create the user's profile. Each user is given a unique profile.

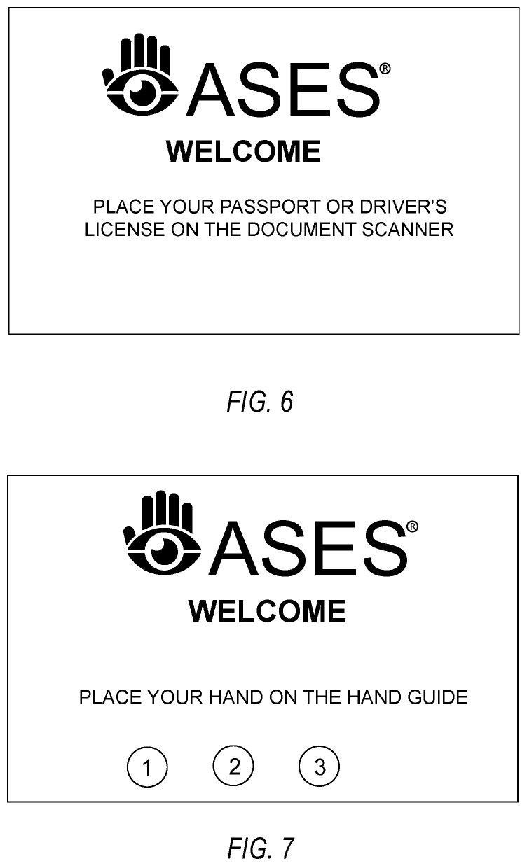

FIG. 4 shows that the method 400 can further include obtaining 406 the user's identification. Typically, identification will be a user's government issued identification (passport, driver's license, etc.). However, the identification can include other types of identification (employee i.d., student i.d., etc.). The i.d., requirements can be changed to accommodate the needs of the kiosk owner. For example, an employer may prefer employee i.d. over other types of i.d., whereas a government building may prefer a driver's license and an airport may prefer government issued identification. An example of a screen requesting appropriate identification can be seen in FIG. 6.

FIG. 4 shows that the method 400 can additionally include associating 408 the user's identification with the user's profile. The user's identification is placed in the user's profile to allow for faster registration processes in the future, or to allow security officials to see the user's identification when needed. For example, if a user scans in a government issued identification for entry, then the user's identification can be placed on a screen where it is viewed by security officials.

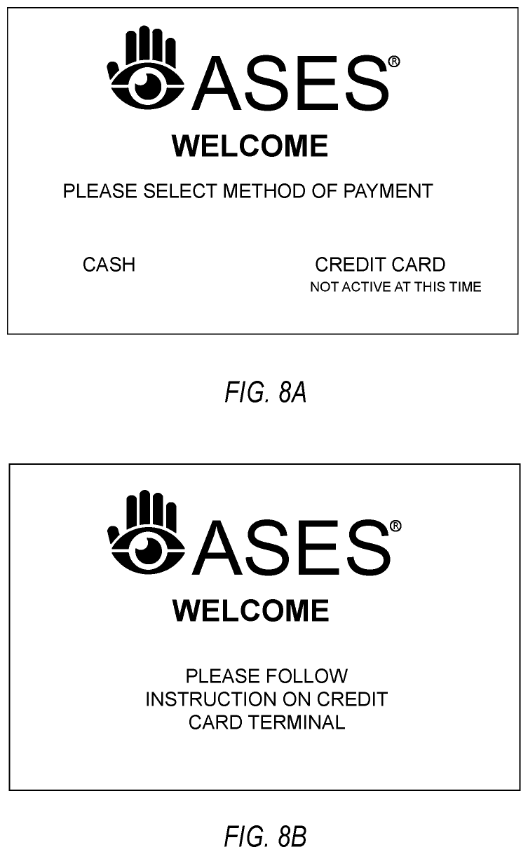

FIG. 4 shows that the method 400 can moreover include obtaining 410 biometric data from the user. Biometric data can be obtained 410 to speed up the entry process. For example, a face scan can allow lines to move at walking speed. Palm scans or fingerprint scans can allow lines to move almost at walking speed. In addition, biometric data is harder to fake or imitate, meaning that biometric data is more secure once it is obtained 410. An example of a screen requesting biometric data can be seen in FIG. 7.

FIG. 4 shows that the method 400 can also include associating 412 the biometric data with the user's profile. The biometric data is associated 412 with the user's profile to allow for faster registration in the future or to speed the entry process. For example, if a face scan is part of the biometric data then the face's of entrants can be scanned and compared with stored face scans. A match can lead to automatic entry whereas a failure to match can lead to an alert to security personnel.

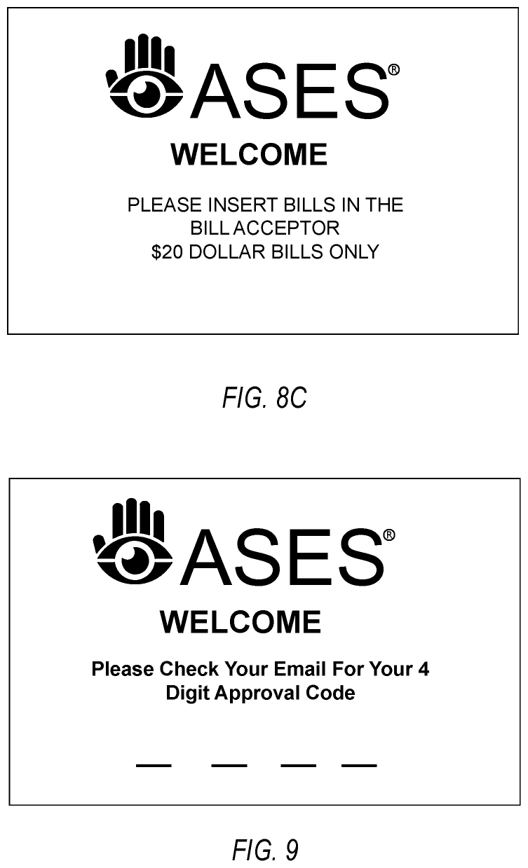

FIG. 4 shows that the method 400 can further include receiving 414 a payment from the user. Not every process will require payment. For example, if the user is registering for a concert or other performance, then payment will be required, but if the user is registering as a new employee, then payment may not be required. In addition, the payment available to a user can be customized based on the needs of the kiosk owner. An example of a payment screen can be seen in FIGS. 8A, 8B and 8C.

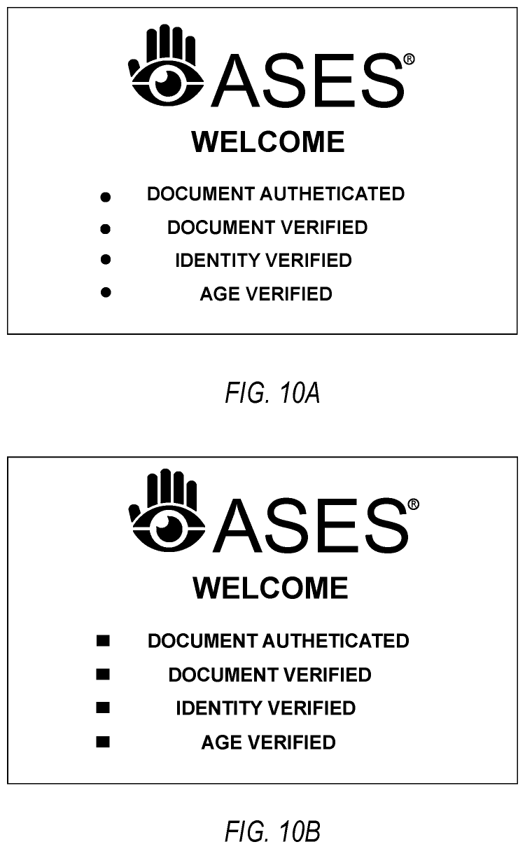

FIG. 4 shows that the method 400 can also include sending 416 the user a code. Sending 416 the user a code can allow for two-factor authentication. Two-factor authentication is an authentication method that requires two factors (password, code, biometric data) to be authenticated. For example, the user can be emailed a code during the registration process. The user then has to enter the code to confirm that he/she received the email. An example of a screen requiring the code sent 416 to the user can be seen in FIG. 9.

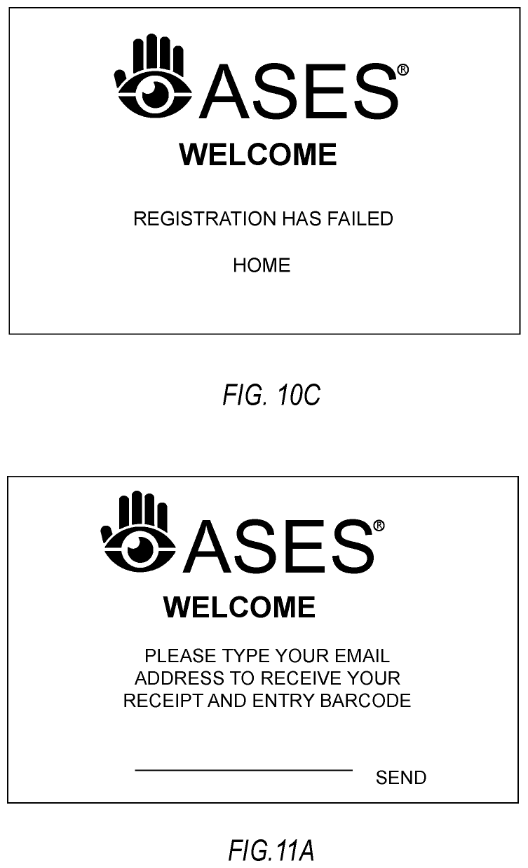

FIG. 4 shows that the method 400 can additionally include completing 418 registration. Completing 418 registration allows the user to take advantage of the registration. For example, if the user is purchasing an event ticket, then registration allows the user to enter the event. Likewise, if the user is a new employee then the employee can enter the secure area in the future. An example of a completed registration checklist can be seen in FIG. 10A. An example of an incomplete registration checklist can be found in FIG. 10B. An example of a screen showing successful registration can be seen in FIG. 10C.

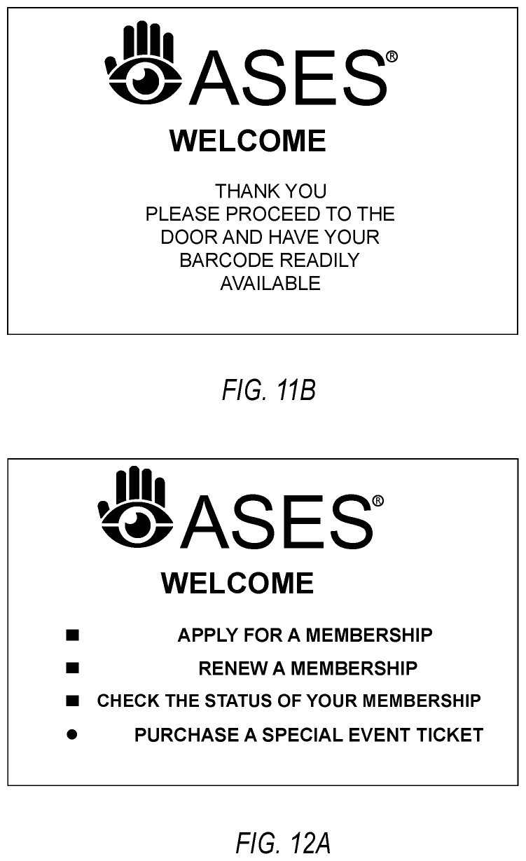

FIG. 4 shows that the method 400 can moreover include providing 420 entry to a secure area. Since the goal of registration is to allow entry to a secure area, then it will often be the case that immediate entry is required. That entry can be granted via the security kiosk or via an access portal that the user then proceeds to. An example of a screen showing completed registration and entry instructions can be seen in FIG. 11A. An alternative example of a screen showing completed registration and allowing entry can be seen in FIG. 11B.

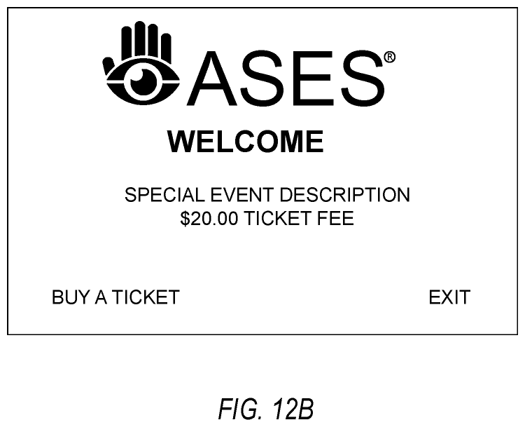

The method of special even registration will be similar to, but less intensive than, the method 400 of FIG. 4. Special event registration may be a one-time event. I.e., if the security kiosk is to be used for access to a location where the user will need to come and go regularly (e.g. a workplace) then permanent registration will be beneficial; on the other hand, events that are one-time (e.g., a concert) may have many single use users. These user's need only be provided once (or a few times which are time limited) and so the registration process may be less intensive. An example of a welcome screen for a onetime registration can be seen in FIGS. 12A and 12B.

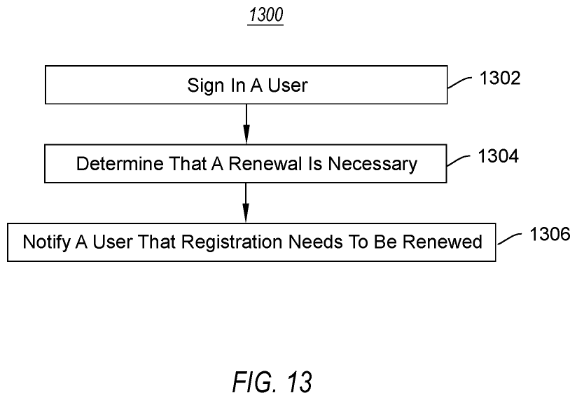

FIG. 13 is a flow chart illustrating a method 1300 of allowing a user to renew a registration on a security kiosk. As with a new registration, a registration renewal will often be better handled at a kiosk that does not provide entry, because renewals take longer than an average entrant. However, there may be times (e.g., if the flow of entrants is low but steady) where registration renewal is handled at an access portal.

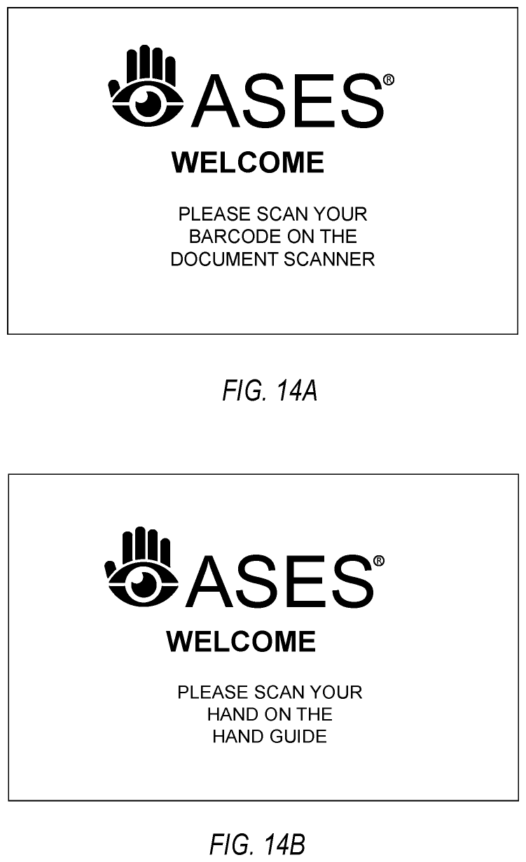

FIG. 13 shows that the method 1300 can include signing in 1302 a user. The sign in 1302 process includes identifying the user. If the user is not known, then there cannot be a determination whether a renewal needs to occur. Therefore, the user has to be signed in 1302 before a need for renewal can be identified. An example of a sign-in prompt can be seen in FIGS. 14A and 14B.

FIG. 13 shows that the method 1300 can also include determining 1304 that a renewal is necessary. The user's profile is checked to determine 1304 that renewal will be required. Renewal may be required based on a number of factors. For example, renewal can be required at certain time intervals, which can ensure that user's information remains correct. Alternatively, renewal can be required if payment is required or if funds in an attached account are low, if the user's identification is expired, etc.

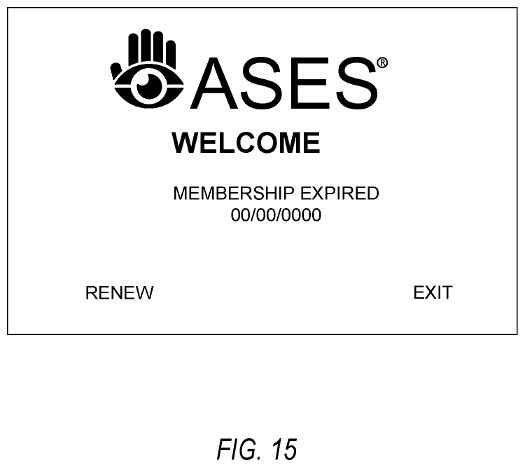

FIG. 13 shows that the method 1300 can include notifying 1302 a user that registration needs to be renewed. This can come before the actual renewal is due. I.e., the notification 1302 can be before the actual due date. For example, the user can be prompted that a renewal will be due in the 30 days before the renewal is due. This gives the user time to complete the renewal. An example of a renewal prompt can be seen in FIG. 15.

One of skill in the art will appreciate that the renewal process can then include one or more of the steps of the initial registration. That is, the steps of the renewal process will constitute steps that are likewise involved in the registration process (as described in FIG. 4). Thus, those steps do not need to be repeated here. One of skill in the art will further appreciate that registration renewal is a much quicker process than initial registration. In particular, the process needs to verify the account and then process any required renewal steps (e.g., confirmation of data, payment, etc.).

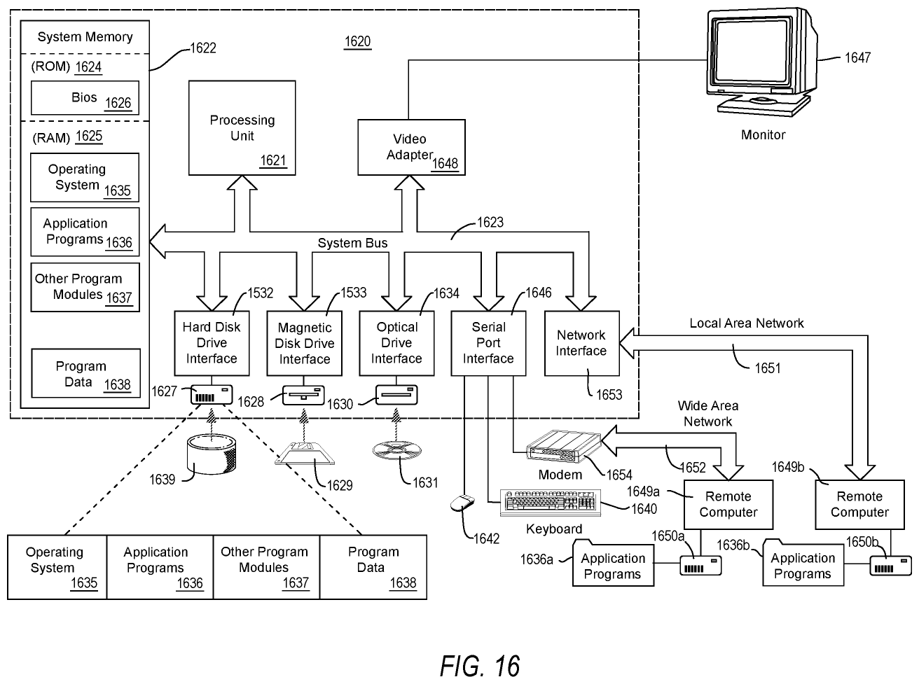

FIG. 16, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 16, an example system for implementing the invention includes a general purpose computing device in the form of a conventional computer 1620, including a processing unit 1621, a system memory 1622, and a system bus 1623 that couples various system components including the system memory 1622 to the processing unit 1621. It should be noted however, that as mobile phones become more sophisticated, mobile phones are beginning to incorporate many of the components illustrated for conventional computer 1620. Accordingly, with relatively minor adjustments, mostly with respect to input/output devices, the description of conventional computer 1620 applies equally to mobile phones. The system bus 1623 may be any of several types of bus structures including a memory bus or memory controller, a peripheral bus, and a local bus using any of a variety of bus architectures. The system memory includes read only memory (ROM) 1624 and random access memory (RAM) 1625. A basic input/output system (BIOS) 1626, containing the basic routines that help transfer information between elements within the computer 1620, such as during start-up, may be stored in ROM 1624.

The computer 1620 may also include a magnetic hard disk drive 1627 for reading from and writing to a magnetic hard disk 1639, a magnetic disk drive 1628 for reading from or writing to a removable magnetic disk 1629, and an optical disc drive 1630 for reading from or writing to removable optical disc 1631 such as a CD-ROM or other optical media. The magnetic hard disk drive 1627, magnetic disk drive 1628, and optical disc drive 1630 are connected to the system bus 1623 by a hard disk drive interface 1632, a magnetic disk drive-interface 1633, and an optical drive interface 1634, respectively. The drives and their associated computer-readable media provide nonvolatile storage of computer-executable instructions, data structures, program modules and other data for the computer 1620. Although the exemplary environment described herein employs a magnetic hard disk 1639, a removable magnetic disk 1629 and a removable optical disc 1631, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 1639, magnetic disk 1629, optical disc 1631, ROM 1624 or RAM 1625, including an operating system 1635, one or more application programs 1636, other program modules 1637, and program data 1638. A user may enter commands and information into the computer 1620 through keyboard 1640, pointing device 1642, or other input devices (not shown), such as a microphone, joy stick, game pad, satellite dish, scanner, motion detectors or the like. These and other input devices are often connected to the processing unit 1621 through a serial port interface 1646 coupled to system bus 1623. Alternatively, the input devices may be connected by other interfaces, such as a parallel port, a game port or a universal serial bus (USB). A monitor 1647 or another display device is also connected to system bus 1623 via an interface, such as video adapter 1648. In addition to the monitor, personal computers typically include other peripheral output devices (not shown), such as speakers and printers.

The computer 1620 may operate in a networked environment using logical connections to one or more remote computers, such as remote computers 1649a and 1649b. Remote computers 1649a and 1649b may each be another personal computer, a server, a router, a network PC, a peer device or other common network node, and typically include many or all of the elements described above relative to the computer 1620, although only memory storage devices 1650a and 1650b and their associated application programs 1636a and 1636b have been illustrated in FIG. 16. The logical connections depicted in FIG. 16 include a local area network (LAN) 1651 and a wide area network (WAN) 1652 that are presented here by way of example and not limitation. Such networking environments are commonplace in office-wide or enterprise-wide computer networks, intranets and the Internet.

When used in a LAN networking environment, the computer 1620 can be connected to the local network 1651 through a network interface or adapter 1653. When used in a WAN networking environment, the computer 1620 may include a modem 1654, a wireless link, or other means for establishing communications over the wide area network 1652, such as the Internet. The modem 1654, which may be internal or external, is connected to the system bus 1623 via the serial port interface 1646. In a networked environment, program modules depicted relative to the computer 1620, or portions thereof, may be stored in the remote memory storage device. It will be appreciated that the network connections shown are exemplary and other means of establishing communications over wide area network 1652 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for confirming an individual's identity prior to access to a secure area, the system comprising:
a network, the network connecting the components of the system to one another;
a database, the database storing information including:
a user profile;
a security kiosk, the security kiosk:
in electronic communication with the database over the network; and
configured to allow a user to confirm his/her identity by sending one or more pieces of identifying information to the database for comparison to the user's profile; and
an access portal, the access portal:
in electronic communication with the database and the security kiosk over the network;
configured to:
prevent access to a secure area prior to confirmation of the user's identify; and
allow access to the secure area after confirmation of the user's identity by the security kiosk.

2. The system of claim 1, wherein the security kiosk requires one or more pieces of identification from the user.

3. The system of claim 2, wherein the one or more pieces of identification include a printed identification.

4. The system of claim 3, wherein the printed identification includes a driver's license.

5. The system of claim 2, wherein the one or more pieces of identification include biometric identification.

6. The system of claim 1, wherein the security kiosk and access portal are located in the same physical component.

7. The system of claim 1, wherein the security kiosk and database are located in the same physical component.

8. The system of claim 1, wherein the access portal and database are located in the same physical component.

9. A security kiosk for confirming a user's identity prior to access to a secure area, the security kiosk comprising:
a memory;
a processor coupled to the memory programmed with executable instructions, the instructions including:
receiving identifying data from a user;
sending the identifying data to a database containing user profiles;
receiving from the database a communication about whether the identifying data matches data in a user profile;
allowing access to a secure area when the identifying data matches data in a user profile; and
preventing access to the secure area when the identifying data does not match data in a user profile;
a touch screen, wherein the touch screen is configured to allow a user to enter and receive information regarding the identifying data; and
a camera, wherein the camera is configured to capture one or more images, the one or more images related to the identifying data.

10. The security kiosk of claim 9, wherein the touch screen presents a user interface to the user.

11. The security kiosk of claim 9 further comprising a scanner, the scanner configured to allow a user to scan identification documents.

12. The security kiosk of claim 9 further comprising a biometric scanner.

13. The security kiosk of claim 12, wherein the biometric scanner includes a fingerprint scanner.

14. The security kiosk of claim 12, wherein the biometric scanner includes a face scanner.

15. The security kiosk of claim 9 further comprising a payment input.

16. The security kiosk of claim 15, wherein the payment input includes a credit card reader.

17. The security kiosk of claim 9 further comprising a printer.

18. A method of allowing a user to register on a security kiosk, the method comprising:
providing a welcome screen;
obtaining the user's identifying information;
obtaining the user's identification;
associating the user's identification with the user's profile;
obtaining biometric data from the user;
associating the biometric data with the user's profile;
receiving a payment from the user;
sending the user a code;
completing registration; and
providing entry to a secure area.

19. The method of claim 18 further comprising, receiving a payment from the user.

20. The method of claim 18, wherein the identifying information includes at least one of:
name;
address;
age; or
physical description.
